(19) United States
(12) Patent Application Publication
(10) Pub. No.: US 2006/0037632 A1
(43) Pub. Date: Feb. 23, 2006

(54) Dish washing machine

(75) Inventors: Hideyuki Nito, Osaka (JP); Kiyoyuki Suo, Osaka (JP); Hajime Suzuki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD, Moriguchi-shi (JP)

(21) Appl. No.: 11/207,008

(22) Filed: Aug. 19, 2005

(30) Foreign Application Priority Data
Aug. 23, 2004 (JP) 2004-241955

(51) Int. Cl. B08B 3/02

(52) U.S. Cl. 134/56 R; 134/94.1; 134/198; 134/102.3; 134/96.1

(57) ABSTRACT

A dish washing machine according to the present invention comprises a first nozzle for spraying wash water toward dishes contained in an upper basket, a second nozzle for spraying wash water toward dishes contained in a lower basket, and a change over means for changing over between supplying and not supplying wash water to the first nozzle. In the dish washing using both of the upper basket and the lower basket, an upper and lower washing operation for spraying wash water from both of the first nozzle and the second nozzle and a lower washing operation for spraying wash water only from the second nozzle are mixedly carried out.

### BACKGROUND OF THE INVENTION

1. Field of the Invention

The present invention relates to a dish washing machine for washing dishes (including chopsticks, cooking utensils and the like), and particularly to a tabletop type dish washing machine to be placed by the side of a sink of a sink cabinet.

2. Description of Related Art

It is necessary for a tabletop type dish washing machine to have a small-sized outline capable of being placed in a limited space on a sink cabinet and at the same time to wash dishes for the standard number of family at a time. Therefore, recently, a dish washing machine including doubly disposed two baskets, namely, an upper and a lower baskets for containing dishes in a washing tank has become the mainstream one.

In a washing machine having doubly disposed two baskets, nozzles are provided, for example, in the bottom portion and on the side surface of the washing tank. Wash water is sprayed toward the lower basket from the lower nozzle provided in the bottom portion. Then, wash water is sprayed toward the upper basket from the upper nozzle provided on the side surface. Thereby, dishes contained in the upper and lower baskets respectively are washed.

However, in a dish washing machine, the greatest washable number of dishes are not always washed, but sometimes a smaller number, than the greatest washable number, of dishes are washed.

Accordingly, when the number of dishes to be washed is small, it can be thought that only the lower basket is used and dishes contained in the lower basket are washed by spraying wash water only from the lower nozzle. Of course, when the number of dishes to be washed is large, both of the upper and lower baskets are used and dishes contained in the upper and lower baskets are washed by spraying wash water from both of the upper and lower nozzles.

For example, in the Patent Publication No. 3162912 issued on May 8, 2001 by Japan Patent Office, disclosed is a structure for changing over between supplying and stopping supplying wash water to an upper nozzle in a washing machine having doubly disposed upper and lower baskets.

However, it has been proved that, with the upper and lower baskets full of dishes, wash water cannot reach all of the dishes and thus some portions of the dishes are left unwashed even though the wash water is sprayed from both the upper and lower nozzles.

Further, it has been proved that, when dishes are contained only in the lower basket and wash water is sprayed only from the lower nozzle, wash water cannot reach especially the upper portions of the dishes and those portions are left unwashed.

### SUMMARY OF THE INVENTION

An object of the invention is to provide a dish washing machine capable of excellent dish washing using both of an upper basket and a lower basket.

Another object of the invention is to provide a dish washing machine capable of excellent dish washing using only a lower basket.

A washing machine according to the present invention comprises a first nozzle for spraying wash water toward dishes contained in an upper basket, a second nozzle for spraying wash water toward dishes contained in a lower basket, and a change over means for changing over between supplying and not supplying wash water to the first nozzle.

When wash water supply to the first nozzle is stopped and wash water is supplied only to the second nozzle, the force of wash water sprayed from the second nozzle becomes stronger in comparison with the case where wash water is supplied to both of the first nozzle and the second nozzle. Therefore, by spraying wash water from both of the first nozzle and the second nozzle or spraying wash water only from the second nozzle with a strong force, wash water can reach all dishes to be washed and excellent dish washing can be achieved in dish washing using both of the upper and lower baskets and dish washing using only the lower basket.

The abovementioned and other objects, features and advantages will become more apparent from the following description given with the appended drawings.

### BRIEF DESCRIPTION OF THE DRAWINGS

FIG. 1 is a right sectional view of a dish washing machine according to an embodiment of the present invention sectioned along a vertical plane in the direction of the depth.

FIG. 2 is a front view of the dish washing machine in a state that an upper door, a lower door, an upper basket and a lower basket are removed therefrom.

FIG. 3 is a longitudinal sectional view of a change over device.

FIG. 4 is a cross sectional view illustrating the inner structure of a stopper driving mechanism in which a stopper is in the state of protruding into a valve chamber (containing section).

FIG. 5 is a cross sectional view illustrating the inner structure of the stopper driving mechanism in which the stopper is in the state of being retracted from the valve chamber.

FIG. 6 is a view showing an arrangement of an operation display panel.

FIG. 7 is a block diagram showing an electric arrangement of the dish washing machine.

FIG. 8 is a view showing a driving circuit of a pump motor provided in a load driving section.

FIG. 9 is a view showing an example of a sequence of dish washing of the dish volume for 5˜6 persons (the number of dishes: 60).

FIG. 10 is a view showing an example of a sequence of dish washing of the dish volume for 3˜4 persons (the number of dishes: 32).

FIG. 11 is a view showing an example of a sequence of dish washing of the dish volume for 1˜2 persons (the number of dishes: 16).

### DETAILED DESCRIPTION OF PREFERRED EMBODIMENTS

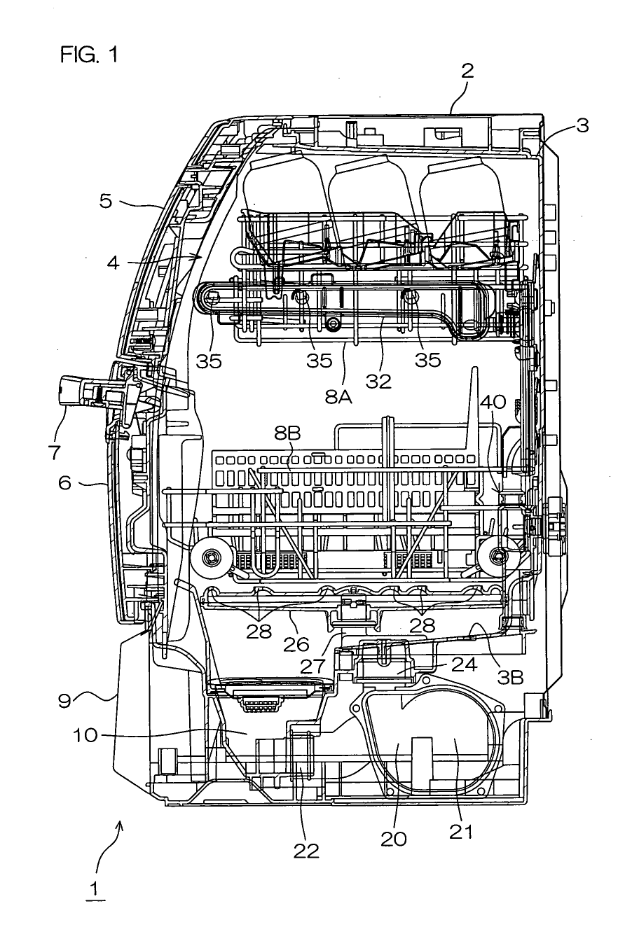

FIG. 1 is a longitudinal sectional view of a washing machine according to an embodiment of the present invention. A dish washing machine 1 shown in FIG. 1 is a tabletop type one to be placed by the side of a sink of a sink cabinet or the like. The outline of the dish washing machine 1 is defined by a substantially rectangular parallelepiped box-shaped body 2.

The box-shaped body 2 is so formed that, for example, its depth is shorter than its width. Disposed within this box-shaped body 2 is a washing tank 3. In one side surface in the direction of depth (the front surface) of the washing tank 3, an opening 4 is provided for putting dishes into and pulling dishes out of the washing tank 3.

In the following description, the words “front, rear, right and left sides” are used on the basis of the directions in the case where the dish washing machine 1 is seen from the side of the opening 4 (the front side).

The opening 4 can be covered with an upper door 5 and a lower door 6 which are attached to the box-shaped body 2. That is, the upper door 5 can cover substantially the upper half of the opening 4 and the lower door 6 can cover substantially the lower half of the opening 4. The upper door 5 has such a structure as to be slightly displaced in the forward direction and then moved in the upward direction along the opening 4. On the other hand, the lower door 6 is pivotally movable in the forward and downward direction about the lower end portion thereof. When the upper door 5 and the lower door 6 are closed, the opening 4 is covered so that the washing tank 3 is water-tightly sealed. Further, when the upper door 5 and the lower door 6 are closed, the lower end portion of the upper door 5 and the upper end portion of the lower door 6 are engaged with each other and at the same time the lower door 6 is locked with respect to the box-shaped body 2 thereby to keep the opening 4 to be covered by the upper door 5 and the lower door 6 (to keep the washing tank 3 to be water-tightly sealed).

Further, provided in the upper door 5 is an exhaust opening 5A communicated with the inside of the washing tank 3.

Provided at the center in the lateral direction of the upper end portion of the lower door 6 is a handle 7, which a user holds at the time of opening the upper door 5 and the lower door 6. When the user holding the handle 7 slightly pushes down and then pulls the same to this side, the lower door 6 can be unlocked and pivotally moved in the forward and downward direction. The upper door 5 is movable in an interlocking manner with the lower door 6 thus to be moved in the upward direction, so that the opening 4 is widely opened.

Further, in front of the dish washing machine 1 (on the front surface of the box-shaped body 2), provided below the lower door 6 is a belowmentioned operation display panel 9 having a variety of operation keys.

In the washing tank 3, an upper basket 8A and a lower basket 8B for containing dishes to be washed are doubly disposed. In the lower basket 8B, dishes, bowls and the like can be contained in line, while in the upper basket 8A, cups, glasses and the like can be contained in line. Further, each of the upper basket 8A and the lower basket 8B is slidable in the direction of the depth. With the upper door 5 and the lower door 6 being opened, each of the baskets 8A and 8B can be forwardly pulled out through the opening 4, so that dishes can be easily put into and out of the washing tank 3.

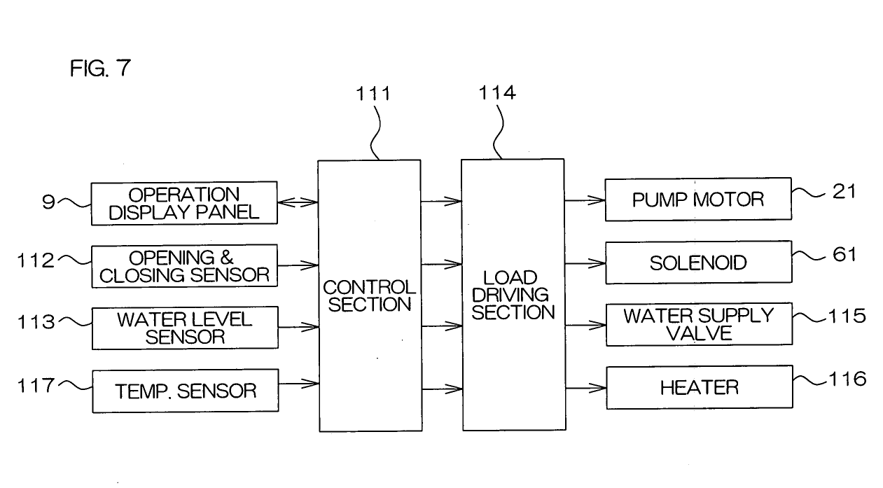

In a front and left portion of the bottom surface 3B of the washing tank 3, a water catchment section 10 is provided in a state of being recessed from the surrounding part. Water or hot water used for dish washing can be supplied into the washing tank 3 through a belowmentioned water supply valve 115 (see FIG. 7), for example, from an outside water supply system or an outside hot water supply system. Water or hot water supplied into the washing tank 3 is stored in the bottom portion of the washing tank 3 including the water catchment section 10.

A mesh-type garbage filter 37 is removably attached to the upper edge portion of the water catchment section 10. This garbage filter 37 catches garbage removed from dishes during washing, so that garbage can be prevented from falling into the water catchment section 10. An upwardly elongated handle 38 is provided at the center of the frond end of the garbage filter 37. Grasping this handle 38A, a user can easily attach or remove the garbage filter 37.

Further, provided below the washing tank 3 and behind the water catchment section 10 is a washing and draining pump 20 for circulating wash water in the washing tank 3 and draining wash water in the washing tank 3. The inside of the washing and draining pump 20 is divided into a washing pump chamber and a draining pump chamber, and the washing pump chamber and the draining pump chamber are provided respectively with a washing impeller and a drain impeller each rotatably driven by a pump motor 21.

An inlet opening of the washing pump chamber is connected to a circulation opening 22 formed in the rear wall of the water catchment section 10, while an outlet opening of the washing pump chamber is connected to a water channel 24 elongated in the direction of the width below the washing tank 3. This water channel 24 is connected to a rotary nozzle arms 26 and a fixed nozzle arm 29 mentioned below. When the pump motor 21 is normally rotated, through the rotation of the washing impeller in the washing pump chamber, wash water is sucked from the water catchment section 10 through the circulation opening 22 into the washing pump chamber, which wash water is then supplied through the outlet opening into the water channel 24. Wash water supplied under pressure thorough the water channel 24 is usually sprayed, through the rotary nozzle arms 26 and the fixed nozzle arm 29 mentioned below, toward dishes in the washing tank 3. Wash water sprayed through the rotary nozzle arms 26 and the fixed nozzle arm 29 is stored again in the bottom portion of the washing tank 3, and sucked from the water catchment section 10 through the circulation opening 22 into the washing and draining pump 20 (washing pump chamber). In such a manner, wash water stored in the water catchment section 10 is circulated within the dish washing machine 1 to be used for washing dishes.

Further, an inlet opening of the draining pump chamber is connected to a drain opening (not shown) formed in the left side wall of the water catchment section 10. An outlet opening of the draining pump chamber is connected to a drain channel (not shown) communicated with the outside of the dish washing machine 1. When the pump motor 21 is reversely rotated, through the rotation of the drain impeller in the draining pump chamber, wash water is sucked from the water catchment section 10 through the drain opening into the draining pump chamber, which wash water is drained through the drain channel to the outside of the dish washing machine 1.

At the bottom of the washing tank 3, two rotary nozzle arms 26 are disposed right and left for spraying wash water upwardly from below the lower basket 8B (in FIG. 1, only one rotary nozzle arms 26 is shown). These two rotary nozzle arms 26 have substantially elliptical long shapes respectively and are supported by a common nozzle shaft 27 so as to be rotated in a horizontal plane about the central portion in the longitudinal direction thereof. The nozzle shaft 27 is communicated with the water channel 24.

A plurality of (for example, six) nozzles 28 are provided in the upper surface of each rotary nozzle arm 26. Wash water supplied from the washing and draining pump 20 through the water channel 24 and nozzle shaft 27 to each rotary nozzle arm 26 is upwardly sprayed through the nozzles 28 of each rotary nozzle arm 26. When wash water is sprayed through the nozzles 28 of each rotary nozzle arm 26, a reaction force is generated to each rotary nozzle arm 26, and by this reaction force, each rotary nozzle arm 26 is rotated with spraying wash water through the nozzles 28. Thereby, dishes disposed above each rotary nozzle arm 26 (dishes mainly contained in the lower basket 8B) are uniformly sprayed with wash water.

Further, this dish washing machine 1 has a function of drying washed dishes. In a front side of the bottom surface 3B of the washing tank 3, a heater 116 (see FIG. 7) is provided for heating wash water stored in the washing tank 3 at the washing time and heating air in the washing tank 3 at the drying time.

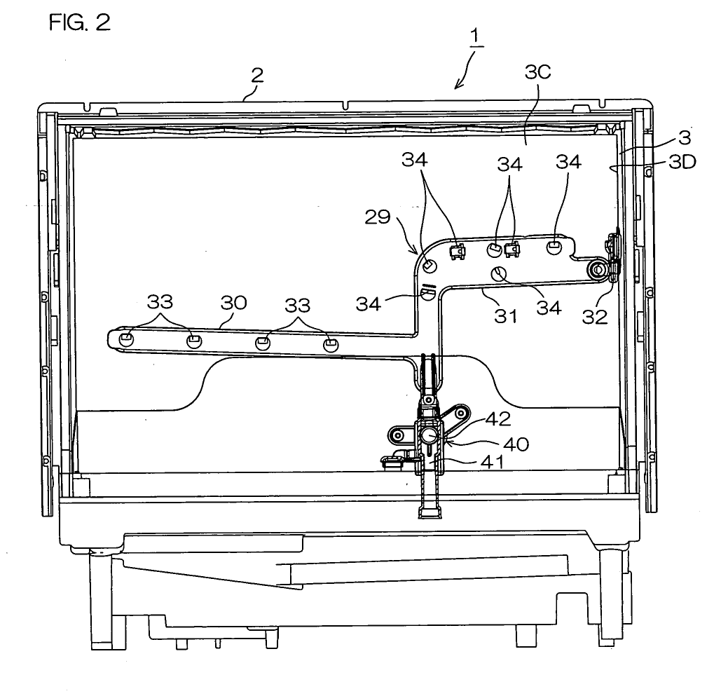

FIG. 2 is a front view of the dish washing machine 1 in a state that an upper door 5, a lower door 6, an upper basket 8A and a lower basket 8B are removed therefrom. As shown in FIG. 2, on the rear surface 3C and the right side surface 3D in the washing tank 3, a fixed nozzle arm 29 is attached for spraying wash water toward dishes contained in the upper basket 8A from between the upper basket 8A and the lower basket 8B. The fixed nozzle arm 29 is elongated upwardly from the lower end thereof, and then, at the midway, branched into a first arm 30 and a second arm 31. Further, a third arm 32 is elongated from the end of the second arm 31. The first arm 30 and the second arm 31 are disposed on the rear surface 3C while the third arm 32 is disposed on the right side surface 3D. The lower end of the fixed nozzle arm 29 is communicated with the water channel 24.

The first arm 30 is branched leftwardly and elongated substantially in the horizontal direction (strictly speaking, somewhat inclined in such a manner that the left end thereof becomes slightly higher) near to the left end of the rear surface 3C. The first arm 30 is provided with a substantially equally spaced plurality of (for example, four) nozzles 33 for upwardly spraying wash water toward dishes contained mainly in the left half portion of the upper basket 8A.

The second arm 31 is elongated further above the branched position of the first arm 30 and then bent rightwardly to extend substantially in the horizontal direction (strictly speaking, somewhat inclined in such a manner that the right end thereof becomes slightly higher) near to the right end of the rear surface 3C. The second arm 31 is provided with a various kinds of nozzles 34 including nozzles for spraying wash water toward the dishes contained in the right half portion of the upper basket 8A and nozzles for spraying wash water toward the upper portions of the large dishes, medium-sized dishes and the like contained in the lower basket 8B.

The third arm 32 is disposed on the right side wall 3D and elongated forwardly substantially in the horizontal direction. The end of the third arm 32 reaches near the opening 4. The third arm 32 is provided with a plurality of (for example, three) nozzles 35 for spraying wash water obliquely from the lower portion toward dishes contained in the upper basket 8A, especially cups, glasses and the like as shown in FIG. 1.

At the root portion (below the branched portion of the first arm 30) of the fixed nozzle arm 29, provided is a changeover device 40 for changing over between flowing and not flowing wash water through the fixed nozzle arm 29. In this dish washing machine 1, by providing this changeover device 40, wash water can be sprayed from both of the rotary nozzle arms 26 and the fixed nozzle arm 29 with the wash water channel from the water channel 24 to the fixed nozzle arm 29 being kept in the opened state. Further, with the wash water channel from the water channel 24 to the fixed nozzle arm 29 being kept in the closed state, wash water can be sprayed only from the rotary nozzle arms 26.

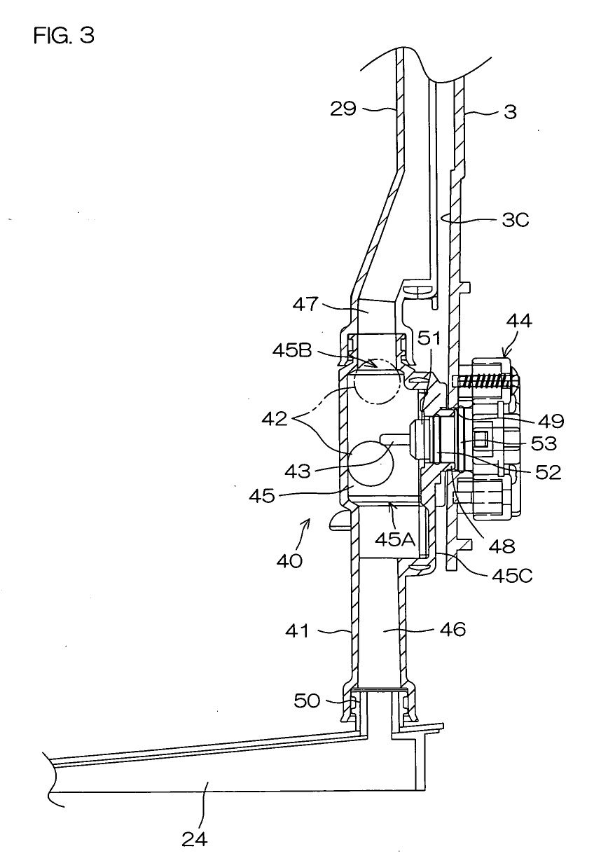

FIG. 3 is a longitudinally sectional view of the changeover device 40. As shown in FIG. 3, the changeover device 40 comprises a valve chamber 41 connecting the root portion of the fixed nozzle arm 29 and the water channel 24 to each other, a ball-shaped valve body 42 contained in the valve chamber 41 and formed of a resin material having a specific gravity larger than that of water (for example, specific gravity 2), a stopper 43 for restricting the movement of the valve body 42 in the valve chamber 41, and a stopper driving mechanism 44 for driving the stopper 43.

In the valve chamber 41, formed are a containing section 45 for containing the valve body 42, an introducing section 46 for connecting an inlet 45A provided at the lower end of the containing section 45 to the water channel 24, and a leading section 47 for connecting an outlet 45B provided at the upper end of the containing section 45 to the fixed nozzle arm 29.

The inlet 45A is in a substantially rectangular shape in plan view and the width from right to left thereof is smaller than the outer diameter of the valve body 42. Thereby, the valve body 42 in the containing section 45 does not enter through the inlet 45A into the introducing section 46 side. On the other hand, the outlet 45B is in a substantially circular shape in plan view and the inner diameter thereof is smaller than the outer diameter of the valve body 42. Thereby, the valve body 42 in the containing section 45 does not enter through the outlet 45B into the side of the leading section 47.

The rear surface (outer surface) of the containing section 45 is in contact with the rear surface 3C of the washing tank 3. Provided on the rear wall 45C of the containing section 45 is a substantially cylindrical shaped cylindrical section 48 so as to protrude rearward. Provided on the rear wall of the washing tank 3 is an opening 49 having substantially the same inner diameter with the outer diameter of the cylindrical section 48.

By fitting the lower end portion of the containing section 46 of the valve chamber 41 on a connection pipe 50 protruding from the water channel 24, fitting the leading section 47 into the lower end portion of the fixed nozzle arm 29, and at the same time inserting the cylindrical section 48 into the opening 49, the valve chamber 41 is fixed to the rear surface 3c of the washing tank 3.

The stopper 43 is a bar-shaped member elongated in the direction of the depth. The front end portion of the stopper 43 protrudes into the containing section 45. The rear end portion of the stopper 43 is held by the stopper driving mechanism 44 attached to the rear wall of the washing tank 3 from rearward.

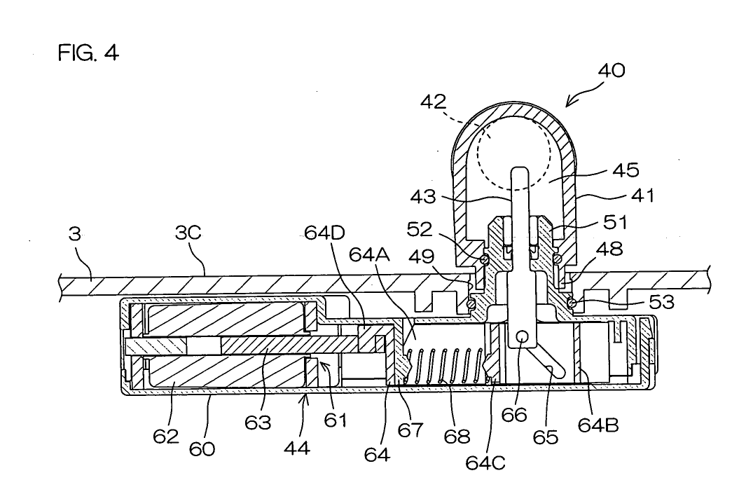

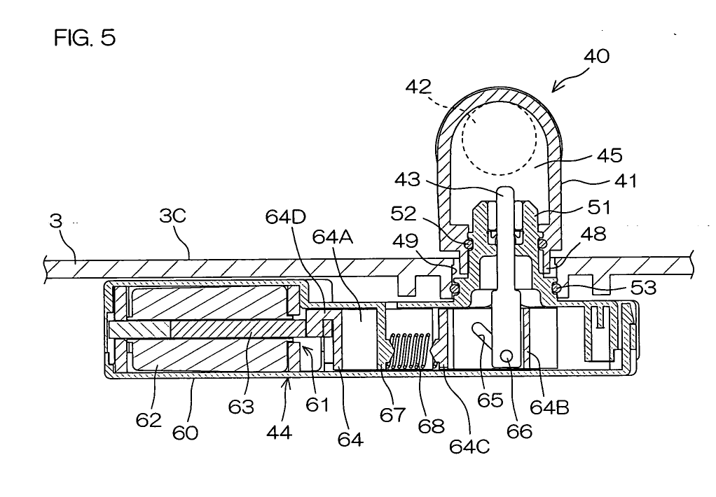

FIGS. 4 and 5 are cross sectional views illustrating the inner structure of the stopper driving mechanism 44. FIG. 4 shows the stopper 43 in a state of protruding into the valve chamber 41 (containing chamber 45) FIG. 5 shows the stopper 43 in a state of being retracted from the valve chamber 41.

The outline of the stopper driving mechanism 44 is defined by a substantially hollow rectangular parallel-piped casing 60 elongated in the direction of the width. On the right side of the front surface of the casing 60, provided is a holding section 51 penetrated into the opening 49 of the washing tank 3 and the cylindrical section 48 of the valve chamber 41 and adapted to slidably hold the stopper 43 in the direction of the depth.

On the outer circumferential surface of the holding section 51, two O-rings 52, 53 are put with a predetermined space therebetween. The O-ring 52 on the front side comes into close contact with the inner surface of the cylindrical section 48 of the valve chamber 41 thereby to water-tightly seal the clearance between the holding section 51 and the cylindrical section 48. The O-ring 53 on the rear side comes into close contact with the opening 49 of the washing tank 3 thereby to water-tightly seal the clearance between the holding section 51 and the opening 49. Thus, wash water leakage from the clearance between the holding section 51 and the cylindrical section 48 of the valve chamber 41 can be prevented. If wash water leaks from the clearance, the O-ring 53 on the rear side can prevent the wash water from leaking to the outside of the washing tank 3.

In the left end portion of the inside of the casing 60, provided is a solenoid 61 to be driven for forwarding and retracting the stopper 43. The solenoid 61 comprises a substantially cylindrical electromagnet 62 and a laterally elongated bar-shaped plunger 63 penetrated through the electromagnet 62. The plunger 63 is formed of a ferromagnetic material (for example, iron). By energizing the solenoid 61 with a driving current (by turning on the solenoid 61), the electromagnet 62 is magnetized, so that the plunger 63 is attracted toward the inside of the electromagnet 62 (leftwardly).

Connected to the right end portion of the plunger 63 of the solenoid 61, is a link member 64 for transmitting a displacement of the plunger 63 to the stopper 43 thus to forward or retract the stopper 43. The link member 64 comprises a lower plate section 64A laterally elongated along the bottom surface of the casing 60, a right plate section 64B upwardly protruding from the right end of the lower plate section 64A, a left plate section 64C upwardly protruding on the left side of the right plate section 64B with a predetermined space from the right plate section 64, and a connecting section 64D formed at the left end of the lower plate section 64A and connected with the plunger 63. In the lower plate section 64A between the right plate section 64B and the left plate section 64C, provided is an engagement groove 65 obliquely elongated from the left front side to the right rear side. Fixed to the rear end portion of the stopper 43 is a downwardly protruding engagement pin 66, the lower end portion of which is fitted into the engagement groove 65.

As shown in FIG. 4, when the engagement pin 66 is in the left end portion of the engagement groove 65, the stopper 43 is forwarded to a restricting position in which the distance between the leading end of the stopper 43 and the inner front surface of the containing section 45 is smaller than the outer diameter of the valve body 42 so that the movement of the valve body 42 striding over the stopper 43 is restricted. On the other hand, as shown in FIG. 5, when the engagement pin 66 is in the right end portion of the engagement groove 65, the stopper 43 is retracted to an allowing position in which the distance between the leading end of the stopper 43 and the inner front surface of the containing section 45 is larger than the outer diameter of the valve body 42 so that the movement of the valve body 42 in the valve chamber 41 is allowed.

In the casing 60, between the left plate section 64C and the connecting section 64D of the link member 64, formed is an inner wall 67 rearwardly protruding from the inner front surface of the casing 60. Between the inner wall 67 and the left plate section 64C of the link member 64, disposed is a spring 68 by which the link member 64 is energized rightwardly (in the direction of forwarding the stopper 43).

When the washing and draining pump 20 is normally rotated with the valve body 42 being situated in the lower portion of the containing section 45 (below the stopper 43) and the stopper 43 being forwarded to the restricting position, wash water flows through the water channel 24 into the valve chamber 41, so that the water pressure of the wash water pushes the valve body 42 upwardly. At this time, since the stopper 43 restricts the upward movement of the valve body 42, the valve body 42 does not move to a position above the stopper 43, and the outlet 45B is not closed by the valve body 42. Therefore, wash water flowing into the valve chamber 41 flows from the valve chamber 41 through the outlet 45B into the fixed nozzle arm 29 thus to be sprayed from the nozzles 33, 34, 35 provided in the fixed nozzle arm 29.

On the other hand, the solenoid 61 is turned ON, the plunger 63 is attracted leftwardly and the link member 64 is displaced leftwardly against the energizing force of the spring 68, so that the stopper 43 is retracted to the retracting position. By normally rotating the washing and draining pump 20 in this state, wash water flows from the water channel 24 into the valve chamber 41 and the valve body 42 is pushed upwardly by the water pressure. Since the movement of the valve body 42 is allowed at this time, the valve body 42 is pushed upwardly above the stopper 43, so that the valve body 42 is fitted into the outlet 45B to close the outlet 45B. Thereby, wash water supply from the valve chamber 41 into the fixed nozzle arm 29 is prevented. As a result, wash water supplied into the water channel 24 by the washing and draining pump 20 is sprayed only from the rotary nozzle arms 26. In the case where wash water is sprayed only from the rotary nozzle arms 26, the amount of wash water flowing through the rotary nozzle arms 26 becomes larger by the amount not supplied into the fixed nozzle arm 29 (the water pressure becomes larger) in comparison with the case where wash water is sprayed from both the rotary nozzle arms 26 and the fixed nozzle arm 29, so that the force of wash water sprayed from the rotary nozzle arms 26 becomes stronger.

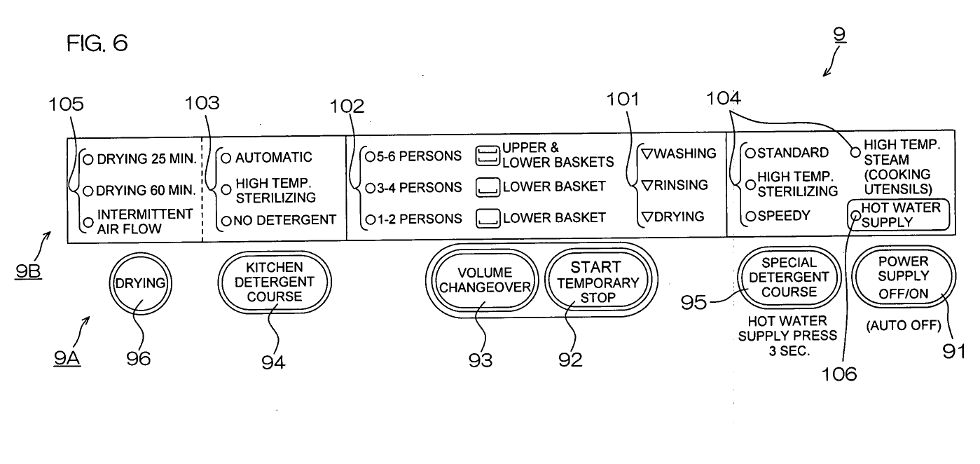

FIG. 6 is a view showing an arrangement of an operation display panel 9. The operation display panel 9 comprises an operation key arrangement section 9A in which various kinds of operation keys are arranged and a display lamp arrangement section 9B in which lamps and the like are arranged.

In the operation key arrangement section 9A, arranged are a power supply switch 91 for changing over ON/OFF of the power supply, a start/temporary stop key 92 for starting/temporarily stopping the operation of the dish washing machine 1, a volume changeover key 93 for changing over the volume of the dishes to be washed by three stages, a kitchen detergent course key 94 for selecting and setting a kind of kitchen detergent course using a kitchen detergent for washing dishes (an automatic course, a high temperature sterilizing course or a no-detergent course), a special detergent course key 95 for selecting and setting a kind of special detergent course using a special detergent (a standard course, a high temperature sterilizing course, a speedy course or a high temperature steam course), and a drying key 96 for selecting and setting a kind of drying operation for drying washed dishes (25 minutes' drying, 60 minutes' drying, or intermittent air blowing).

The “automatic course” of the kitchen detergent course is a course in which the washing operation time or the like is automatically set according to the soiled extent of dishes.

The “no-detergent course” of the kitchen detergent course is a course in which dishes are washed without using any detergent.

The “standard course” is a standard course using a special detergent and capable of cleanly washing dishes (soiled dishes requiring soaking when washed by hands) to which oily soil, rice grain or the like is adhered.

The “speedy course” of the special detergent course is a course for washing slightly soiled dishes in a short time.

The “high temperature steam course” is a course for washing cooking utensils or the like to which sticky soil is adhered using high temperature steam at about 80° C.

The “high temperature sterilizing course” of the kitchen detergent course and the special detergent course is a course for rinsing washed dishes with hot water at about 80° C. and capable of cleanly washing away sticky oily soils or the like adhered to dishes by high temperature hot water rinsing which cannot be performed in washing by hands.

In the display lamp arrangement section 9B, arranged are a progress stage display lamp 101 for displaying the progress stage of the washing operation, a volume display lamp 102 for displaying the dish volume (dishes for 1˜2 persons, 3˜4 persons or 5˜6 persons) set by the volume changeover key 93, a kitchen detergent course display lamp 103 for displaying the kind of the kitchen detergent course set by the kitchen detergent course key 94, a special detergent course display lamp 104 for displaying the kind of the special detergent course set by the special detergent course key 95, and a drying display lamp 105 for displaying the kind of the drying operation set by the drying key 96. Further, in the case of supplying hot water into the dish washing machine 1 from the hot water supply system, a hot water supplying course can be set by continuously pressing the special detergent course key 95 for three minutes. In the display lamp arrangement section 9B, provided is a hot water supply lamp 106 for displaying that the hot water supplying course has been set.

FIG. 7 is a block diagram showing the electric arrangement of the dish washing machine 1. The dish washing machine 1 is provided with a control section 111 including a microcomputer.

The operation display panel 9 is connected to the control section 111 so that operation signals of the various kinds of operation keys such as the power supply switch 91 arranged in the operation panel 9 can be inputted into the control section 111. Further, connected to the control section 111 are an opening and closing sensor 112 for outputting a signal in response to releasing of the lock of the lower door 6, a water level sensor 113 the output of which changes corresponding to the change of the water level of wash water stored in the bottom portion of the washing tank 3, and a temperature sensor 117 for detecting the temperature of wash water stored in the bottom portion of the washing tank 3. The control section 111 can detect the opening or the closing of the upper door 5 and the lower door 6 on the basis of an input signal from the opening and closing sensor 112. The control section 111 can detect the water level of the wash water stored in the bottom portion of the washing tank 3 on the basis of the change of an input signal from the water level sensor 113. Further, the control section 111 can detect the water temperature of the wash water stored in the bottom portion of the washing tank 3 on the basis of an input signal from the temperature sensor 117.

On the basis of signals inputted from the operation display panel 9, the opening and closing sensor 112, a water level sensor 113 and the temperature sensor 117, the control section 111 controls the driving of the pump motor 21, solenoid 61, a water supply valve 115 for changing over between the water supply and the water supply stopping to the washing tank 3, a heater 116 and the like through a load driving section 114. Further, the control section 111 controls the lighting of the lamps such as the progress stage display lamp 101 arranged in the operation display panel 9.

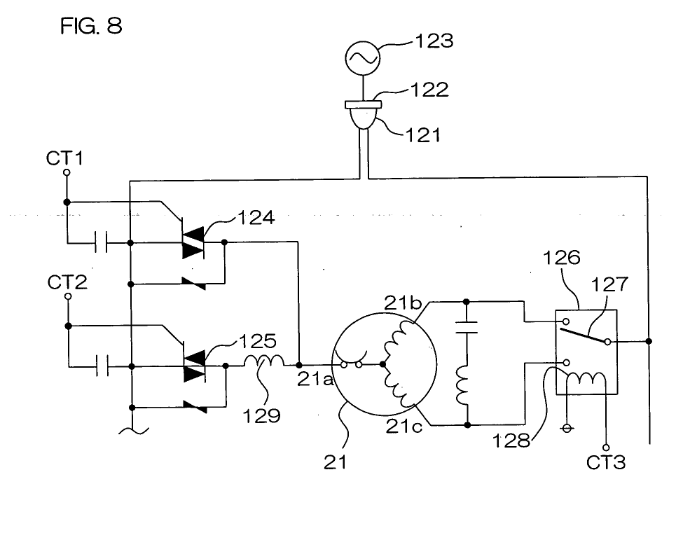

FIG. 8 is a view showing a driving circuit of a pump motor 21 provided in a load driving section 114. This driving circuit of the pump motor 21 includes a first triac 124 and a second triac 125 connected between a commercial alternate power source 123 and a terminal 21a of the pump motor 21 and an electro magnetic relay 126 connected between the commercial alternate power source 123 and terminals 21b, 21c of the pump motor 21 when a plug 121 is inserted into an outlet 122.

The first triac 124 and the second triac 125 are connected in parallel to each other between the commercial alternate power source 123 and the terminal 21a of the pump motor 21 and are turned ON/OFF by control signals CT1, CT2 respectively inputted from the control section 111.

The electromagnetic relay 126 is provided with a contact 127 for changeover the contact point of the commercial alternate power source 123, and a coil 128 for changing over the operation of the contact 127. In response to ON/OFF of a control signal (excitation signal) CT3 inputted from the control section 111 into the coil 128, the contact point of the contact 127 is changed over between the terminal 21b and the terminal 21c of the pump motor 21.

When the first triac 124 or the second triac 125 is turned ON with the contact 127 of the electromagnetic relay 126 being connected to one terminal 21b of the pump motor 21, the pump motor 21 is normally rotated. On the other hand, when the first triac 124 or the second triac 125 is turned ON with the contact 127 of the electromagnetic relay 126 being connected to the other terminal 21c of the pump motor 21, the pump motor 21 is reversely rotated.

Further, between the second triac 125 and the terminal 21a of the pump motor 21, a coil 129 is interposed. Thereby, with the contact 127 of the electromagnetic relay 126 being connected to one terminal 21b of the pump motor 21, when the first triac 124 is turned ON (and the second triac 125 is turned off) a relatively large current is supplied to the pump motor 21, and when the second triac 125 is turned ON (and the first triac 124 is turned off), a relatively small current is supplied to the pump motor 21. Therefore, By selectively turning on the first triac 124 or the second triac 125 thus to changeover the current to be supplied to the pump motor 21 between large and small, the ability of the washing and draining pump 20 can be changed over between HIGH and LOW.

Here, the ability of the washing and draining pump 20 is determined by the discharge pressure of the washing and draining pump 20. The discharge pressure of the washing and draining pump 20 is determined by the rotation speed of the pump motor 21. That is, a state that the ability of the washing and draining pump 20 is “HIGH” is a state that the discharge pressure of the washing and draining pump 20 is relatively high, while a state that the ability of the washing and draining pump 20 is “LOW” is a state that the discharge pressure of the washing and draining pump 20 is relatively low. In this dish washing machine 1, when the ability of the washing and draining pump 20 is “HIGH”, the pump motor 21 is rotated at 3000 rpm, while the ability of the washing and draining pump 20 is “LOW”, the pump motor 21 is rotated at 2300 rpm.

By changing over the ability of the washing and draining pump 20 between HIGH and LOW, the force (strength) of wash water sprayed from the rotary nozzle arms 26 (and the fixed nozzle arm 29) can be changed. That is, by driving the washing and draining pump 20 as a washing pump with the ability of the washing and draining pump 20 being HIGH, the force of wash water sprayed from the rotary nozzle arms 26 (and the fixed nozzle arm 29) can be made high. By driving the washing and draining pump 20 as a washing pump with the ability of the washing and draining pump 20 being LOW, the force of wash water sprayed from the rotary nozzle arms 26 (and the fixed nozzle arm 29) can be made low.

Further, as abovementioned, the force of wash water sprayed from the rotary nozzle arms 26 (and the fixed nozzle arm 29) is also different in the case of being sprayed only from the rotary nozzle arms 26 and in the case of being sprayed from both of the rotary nozzle arms 26 and the fixed nozzle arm 29. That is, in the case where wash water is sprayed only from the rotary nozzle arms 26, the force of wash water sprayed from the rotary nozzle arms 26 becomes high, because the wash water amount flowing through the rotary nozzle arms 26 increases by the wash water amount not to be supplied into the fixed nozzle arm 29 (the water pressure increases) even if the ability of the washing and draining pump 20 is constant.

Therefore, the force of wash water sprayed from the rotary nozzle arms 26 is determined by a combination of the state of the ability of the washing and draining pump 20 and the presence or the absence of wash water spraying from the fixed nozzle arm 29. In the lower washing operation with wash water being sprayed only from the rotary nozzle arms 26, when the washing and draining pump 20 with the “HIGH” ability is driven, the force of the wash water sprayed from the rotary nozzle arms 26 becomes the highest. Next, in the lower washing operation, when the washing and draining pump 20 with the “LOW” ability is driven, the force of the wash water sprayed from the rotary nozzle arms 26 becomes high. The force of the wash water sprayed from the rotary nozzle arms 26 becomes further higher when in the upper and lower washing operation with wash water being sprayed both from the rotary nozzle arms 26 and the fixed nozzle arm 29, the washing and draining pump 20 with the “HIGH” ability is driven. In the upper and lower washing operation, when the washing and draining pump 20 with the “LOW” ability is driven, the force of the wash water sprayed from the rotary nozzle arms 26 becomes the lowest. The abovementiond relations can be summed up in the following table.

| | HIGH | LOW |
|---|---|---|
| Upper & Lower Washing | 3 | 4 |
| Lower Washing | 1 | 2 |

In this table, the force of wash water sprayed from the rotary nozzle arms 26 is represented by “1” to “4” in the order from the highest to the lowest.

Here, at the time of upper and lower washing operation, the force of wash water sprayed from the rotary nozzle arms 26 is as low as “3” or “4”. Therefore, when only the upper and lower washing operation is carried out in the washing using the upper basket 8A and the lower basket 8B and especially when the upper basket 8A and the lower basket 8B are full of dishes, it is feared that neither wash water sprayed from the rotary nozzle arms 26 nor wash water sprayed from the fixed nozzle arm 29 cannot reach some portions of dishes in the upper basket 8A and the lower basket 8B. Further, when only the lower washing operation is carried out in the washing using only the lower basket 8B (washing of the dish volume for 3˜4 persons or 1˜2 persons), it is feared that wash water cannot reach the upper portion of the dishes because wash water is interrupted by dishes contained in the lower basket 8B even if the force of wash water sprayed from the rotary nozzle arms 26 is high.

Therefore, in this dish washing machine 1, in the dish washing using the upper basket 8A and the lower basket 8B, the upper and lower washing operation and the lower washing operation are mixedly carried out. Thereby, since wash water of the force “1” or “2” is sometimes sprayed from the rotary nozzle arms 26, wash water can reach all of the contained dishes even if the upper basket 8A and the lower basket 8B are full of dishes, so that excellent dish washing can be achieved. Further, in the dish washing using only the lower basket 8B, the upper and lower washing operation and the lower washing operation are mixedly carried out. Thereby, since wash water is sometimes sprayed from above toward the dishes contained in the lower basket 8B, wash water can reach the portions of the dishes which are hard to be sprayed with wash water from the rotary nozzle arms 26 disposed below the lower basket 8B, so that excellent dish washing can be achieved.

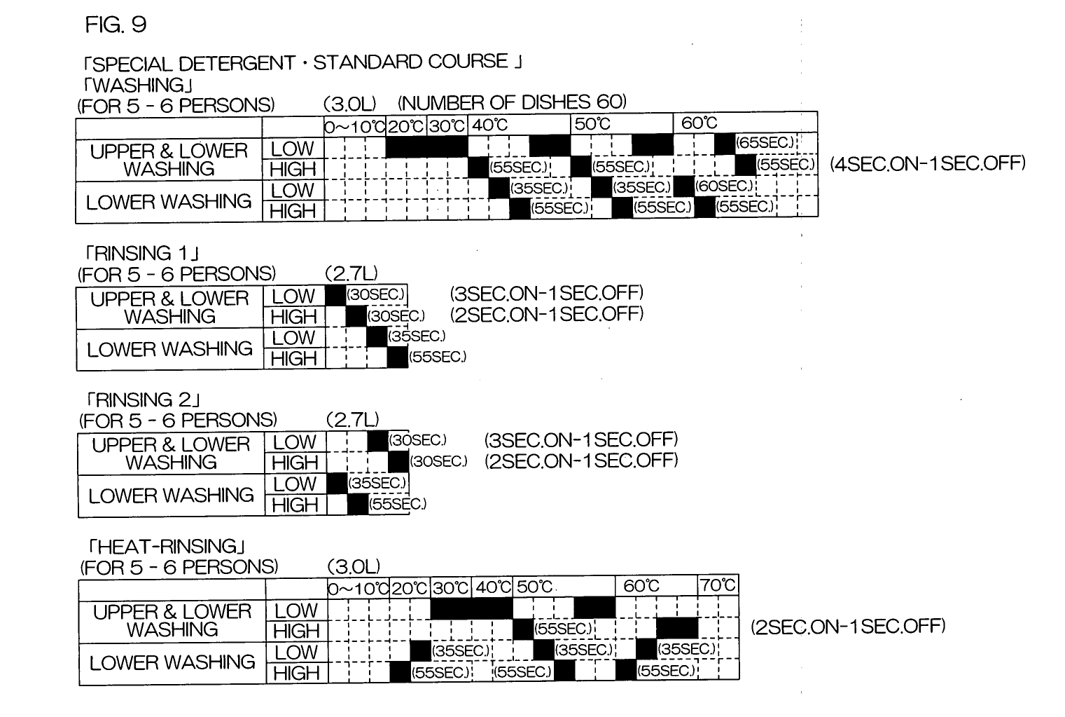

FIG. 9 is a view showing an example of a sequence of dish washing of the dish volume for 5˜6 persons (the number of dishes: 60). The sequence shown in FIG. 9 is applied, for example, when the dish volume for 5˜6 persons is set and the standard course of the special detergent course is selected. At this time, dishes for 5˜6 persons are dividedly contained into the upper basket 8A and the lower basket 8B.

When the start/temporary stop key 92 is pressed, water is supplied into the washing tank 3. When 3 l of water is stored in the washing tank 3, a special detergent is solved in the 3 l of water to make wash water and a “WASHING” step of dishes with the wash water is carried out.

In the “WASHING” step, first, the washing and draining pump 20 is driven with the “LOW” ability with the valve body 42 being situated below the stopper 43, so that the upper and lower washing operation for spraying wash water from both of the rotary nozzle arms 26 and the fixed nozzle arm 29 is carried out. Further, in order to heat wash water stored in the washing tank 3, the heater 116 is energized.

In this dish washing machine 1, in order to surely situate the valve body 42 below the stopper 43 at the beginning of the “WASHING” step, the solenoid 61 is turned ON and its ON state is kept for a predetermined time (for example, 1 second) in response to the pressing of the start/temporary stop key.

When the temperature of wash water reaches 40° C., the ability of the washing and draining pump 20 is changed over to “HIGH” and the force of the wash water sprayed from the rotary nozzle arms 26 changes from “4” to “3”.

When 55 seconds are past after the ability of the washing and draining pump 20 is changed over to “HIGH”, the solenoid 61 is kept ON for a predetermined time. Thereby, the stopper 43 is retracted to the retracting position. While the stopper 43 is retracted to the retracting position, the valve body 42 is pushed upwardly by wash water flowing through the valve chamber 41 and fitted into the outlet 45B. Thereby, wash water supply into the fixed nozzle arm 29 is hindered and the lower washing operation for spraying wash water only from the rotary nozzle arms 26 is carried out. Further, the ability of the washing and draining pump 20 is turned from “HIGH” back to “LOW”. As a result, the force of wash water sprayed from the rotary nozzle arms 26 changes from “3” to “2”.

When 35 seconds are past after the lower washing operation starts, the ability of the washing and draining pump 20 is changed over from “LOW” to “HIGH” again, and the force of wash water sprayed from the rotary nozzle arms 26 changes from “2” to “1”.

When 55 seconds are past after the ability of the washing and draining pump 20 is changed over to “HIGH”, the solenoid 61 is kept ON for a predetermined time and the stopper 43 is retracted to the retracting position, and at the same time the washing and draining pump 20 (pump motor 21) is temporarily stopped. Then, wash water does not flow into the valve chamber 41, and the valve body 42 closing the outlet 45B falls by its own weight down to the lower portion of the valve chamber 41, so that wash water can flow from the valve chamber 41 into the fixed nozzle arm 29. Thereafter, the solenoid 61 is turned OFF (ending of its energization) and thereby the stopper 43 protrudes to the restricting position. By driving the washing and draining pump 20 again with the “LOW” ability with the movement of the valve body 42 being restricted, the upper and lower washing operation for spraying wash water from both of the rotary nozzle arms 26 and the fixed nozzle arm 29 is carried out again. This upper and lower washing operation with the “LOW” ability of the washing and draining pump 20 is continued till the temperature of wash water in the washing tank 3 reaches 50° C.

After the temperature of wash water reaches 50° C., carried out is a control similar to the control carried out when the temperature of wash water rises from 40° C. to 50° C. That is, when the temperature of wash water reaches 50° C., the ability of the washing and draining pump 20 is changed over from “LOW” to “HIGH” and the upper and lower washing operation with the “HIGH” ability of the washing and draining pump 20 is carried out. Thereafter, when 55 seconds are past after the ability of the washing and draining pump 20 is changed over to “HIGH”, the solenoid 61 is turned ON for a predetermined time and at the same time the ability of the washing and draining pump 20 is turned from “HIGH” back to “LOW”, and the lower washing operation with the “LOW” ability of the washing and draining pump 20 is carried out. When 35 seconds are past after the lower washing operation starts, the ability of the washing and draining pump 20 is changed over from “LOW” to “HIGH” again and the lower washing operation with the “HIGH” ability of the washing and draining pump 20 is carried out. When further 55 seconds are past thereafter, the solenoid 61 is kept ON for a predetermined time and at the same time the washing and draining pump 20 (pump motor 21) is temporarily stopped and thereafter the washing and draining pump 20 is driven with the “LOW” ability again, so that the upper and lower washing operation with the “LOW” ability of the washing and draining pump 20 is continued till the temperature of wash water reaches 60° C.

When the temperature of wash water reaches 60° C., the solenoid 61 is turned ON for a predetermined time and the lower washing operation with the “LOW” ability of the washing and draining pump 20 is carried out. When 60 seconds are past after the lower washing operation starts, the ability of the washing and draining pump 20 is changed over from “LOW” to “HIGH” and the lower washing operation with the “HIGH” ability of the washing and draining pump 20 is carried out. When further 55 seconds are past thereafter, the solenoid 61 is kept ON for a predetermined time and at the same time the washing and draining pump 20 (pump motor 21) is temporarily stopped, and thereafter the washing and draining pump 20 is driven again with the “LOW” ability, so that the upper and lower washing operation with the “LOW” ability of the washing and draining pump 20 is started. After the upper and lower washing operation with the “LOW” ability of the washing and draining pump 20 is continued for 65 seconds, the ability of the washing and draining pump 20 is changed over from “LOW” to “HIGH” and the upper and lower washing operation with the “HIGH” ability of the washing and draining pump 20 is carried out. After the upper and lower washing operation with the “HIGH” ability of the washing and draining pump 20 is continued for 55 seconds, the washing and draining pump 20 (pump motor 21) and the heater 116 are turned OFF and the “WASHING” step for washing dishes with wash water containing a special detergent ends.

In the “WASHING” step, in order to reduce the water consumption amount, the amount of wash water to be stored in the bottom portion of the washing tank 3 is limited to 3 l. In this case, when the pump motor 21 is continuously driven with the “HIGH” ability of the washing and draining pump 20, the flow amount of wash water sucked out of the washing tank 3 by the washing and draining pump 20 and sprayed from the rotary nozzle arms 26 and the fixed nozzle arm 29 increases. Therefore, the water level of wash water in the bottom portion of the washing tank 3 is lowered. As a result, a sufficient amount of wash water cannot be stored in the water catchment section 10 and air biting is apt to occur in the washing and draining pump 20. Therefore, in this dish washing machine 1, during the upper and lower washing operation in the “WASHING” step, when the washing and draining pump 20 is driven with the “HIGH” ability, the pump motor 21 is intermittently driven in such a manner that it is normally rotated (ON) for 4 seconds and then stopped (OFF) for 1 second. Thereby, in addition to achieving water saving, excellent dish washing can be achieved by spraying wash water with a strong force from the rotary nozzle arms 26 and the fixed nozzle arm 29, and at the same time occurrence of air biting in the washing and draining pump 20 can be prevented.

When the “WASHING” step ends, the washing and draining pump 20 is reversely rotated and thereby wash water containing a special detergent stored in the washing tank 3 is drained. Then, water is supplied into the washing tank 3. When 2.7 l of water is stored in the washing tank 3, a “RINSING 1” step for rinsing dishes to which wash water containing a special detergent is adhered is started.

In the “RINSING 1” step, first, the washing and draining pump 20 is driven with the “LOW” ability. Since the “WASHING” step ends by the upper and lower washing operation, and the valve body 42 is situated below the stopper 43 at the starting point of the “RINSING 1” step, wash water is sprayed from both of the rotary nozzle arms 26 and the fixed nozzle arm 29 when the washing and draining pump 20 is driven with the “LOW” ability. In other words, the upper and lower washing operation with the “LOW” ability of the washing and draining pump 20 is started.

When 30 seconds are past after the “RINSING 1” step starts, the ability of the washing and draining pump 20 is changed over to “HIGH”. Thereby, the force of wash water sprayed from the rotary nozzle arms 26 changes from “4” to “3”.

When 30 seconds are past after the ability of the washing and draining pump 20 is changed over to “HIGH”, the solenoid 61 is kept ON for a predetermined time and at the same time the ability of the washing and draining pump 20 is turned from “HIGH” back to “LOW”. Thereby, the lower washing operation with the “LOW” ability of the washing and draining pump 20 is started and the force of wash water sprayed from the rotary nozzle arms 26 changes from “3” to “2”.

Thereafter, when 35 seconds are past after the lower washing operation starts, the ability of the washing and draining pump 20 is changed over from “LOW” to “HIGH” again, and the lower washing operation with the “HIGH” ability of the washing and draining pump 20 is started. Thereby, the force of wash water sprayed from the rotary nozzle arms 26 changes from “2” to “1”. After the lower washing operation with the “HIGH” ability of the washing and draining pump 20 is continued for 55 seconds, the washing and draining pump 20 (pump motor 21) is stopped and the “RINSING 1” step ends.

In this “RINSING 1” step, since the amount of wash water to be stored in the washing tank 3 is limited to 2.7 l, which is lesser than that in the “WASHING” step in order to reduce the water consumption amount, air biting is more apt to occur in the washing and draining pump 20 than in the “WASHING” step. Therefore, in the “RINSING 1” step, when the washing and draining pump 20 is driven with the “HIGH” ability in the upper and lower washing operation, the pump motor 21 is intermittently driven in such a manner that it is normally rotated (ON) for 3 seconds and then stopped (OFF) for 1 second. Further, when the washing and draining pump 20 is driven with the “LOW” ability, the pump motor 21 is intermittently driven in such a manner that it is normally rotated (ON) for 2 seconds and then stopped (OFF) for 1 second. Thereby, in addition to achieving further water saving, occurrence of air biting in the washing and draining pump 20 can be reliably prevented.

When the “RINSING 1” step ends, the washing and draining pump 20 is reversely rotated and thereby wash water stored in the washing tank 3 is drained. Then, water is supplied into the washing tank 3 again. When 2.7 l of water is stored in the washing tank 3, a “RINSING 2” step for rinsing dishes is started.

In the “RINSING 2” step, first, the washing and draining pump 20 is driven with the “LOW” ability. Since the “RINSING 1” step ends by the lower washing operation, and the valve body 42 is situated above the stopper 43 at the starting point of the “RINSING 2” step, wash water is sprayed only from the rotary nozzle arms 26 when the washing and draining pump 20 is driven with the “LOW” ability. That is, the lower washing operation with the “LOW” ability of the washing and draining pump 20 is started. In such a manner, since the “RINSING 2” step subsequent to the end of the “RINSING 1” step is started with the lower washing operation, the number of the operations of the solenoid 61 can be reduced and burning of the solenoid 61 (coil) can be prevented.

When 35 seconds are past after the “RINSING 2” step starts, the ability of the washing and draining pump 20 is changed over to “HIGH”. Thereby, the force of wash water sprayed from the rotary nozzle arms 26 changes from “2” to

When 55 seconds are past after the ability of the washing and draining pump 20 is changed over to “HIGH”, the solenoid 61 is kept ON for a predetermined time and at the same time the ability of the washing and draining pump 20 is turned from “HIGH” back to “LOW”. Thereby, the upper and lower washing operation with the “LOW” ability of the washing and draining pump 20 is started and the force of wash water sprayed from the rotary nozzle arms 26 changes from “1” to “4”.

Thereafter, when 30 seconds are past after the upper and lower washing operation starts, the ability of the washing and draining pump 20 is changed over from “LOW” to “HIGH” again, and the upper and lower washing operation with the “HIGH” ability of the washing and draining pump 20 is started. Then, the force of wash water sprayed from the rotary nozzle arms 26 changes from “4” to “3”. When the lower washing operation with the “HIGH” ability of the washing and draining pump 20 is continued for 30 seconds, the washing and draining pump 20 (pump motor 21) is stopped and the “RINSING 2” step ends.

In this “RINSING 2” step, the amount of wash water to be stored in the washing tank 3 is limited to 2.7 l similarly to the case of the “RINSING 1” step. Therefore, when the washing and draining pump 20 is driven with the “HIGH” ability in the upper and lower washing operation, the pump motor 21 is intermittently driven in such a manner that it is normally rotated (ON) for 3 seconds and then stopped (OFF) for 1 second. Further, when the washing and draining pump 20 is driven with the “LOW” ability, the pump motor 21 is intermittently driven in such a manner that it is normally rotated (ON) for 2 seconds and then stopped (OFF) for 1 second. Thereby, in addition to achieving water saving, occurrence of air biting in the washing and draining pump 20 can be reliably prevented.

When the “RINSING 2” step ends, the washing and draining pump 20 is reversely rotated and thereby wash water stored in the washing tank 3 is drained. Then, water is supplied into the washing tank 3 again. When 3 l of water is stored in the washing tank 3, a “HEAT-RINSING” step for rinsing dishes with hot water is started.

In the “HEAT-RINSING” step, first, the heater 116 is energized and the washing and draining pump 20 is driven with the “HIGH” ability. Then, the solenoid 61 is kept ON for a predetermined time, by which the valve body 42 is fitted into the outlet 45B. Thereby, the water supply into the fixed nozzle arm 29 is hindered and the lower washing operation for spraying wash water only from the rotary nozzle arms 26 is carried out.

When 55 seconds are past after the “HEAT-RINSING” step starts, the ability of the washing and draining pump 20 is changed over to “LOW”. Thereby, the force of wash water sprayed from the rotary nozzle arms 26 changes from “1” to “2”.

When 35 seconds are past after the ability of the washing and draining pump 20 is changed over to “LOW”, the solenoid 61 is kept ON for a predetermined time and at the same time the washing and draining pump 20 (pump motor 21) is temporarily stopped. Thereby, the valve body 42 moves to a position below the stopper 43. Thereafter, the washing and draining pump 20 is driven with the “LOW” ability again, so that the upper and lower washing operation for spraying wash water from both of the rotary nozzle arms 26 and the fixed nozzle arm 29 is carried out. Thereby, the force of wash water sprayed from the rotary nozzle arms 26 changes from “2” to “4”.

The upper and lower washing operation with the “LOW” ability of the washing and draining pump 20 is continued till the temperature of wash water in the washing tank 3 reaches 50° C.

After the temperature of wash water reaches 50° C., carried out is a control similar to the control carried out when the temperature of wash water rises from 40° C. to 50° C. That is, when the temperature of wash water in the washing tank 3 reaches 50° C., the ability of the washing and draining pump 20 is changed over from “LOW” to “HIGH” and the upper and lower washing operation with the “HIGH” ability of the washing and draining pump 20 is carried out. Thereafter, When 55 seconds are past after the ability of the washing and draining pump 20 is changed over to “HIGH”, the solenoid 61 is kept ON for a predetermined time and at the same time the ability of the washing and draining pump 20 is turned from “HIGH” back to “LOW”, and the lower washing operation with the “LOW” ability of the washing and draining pump 20 is carried out. When 35 seconds are past after the lower washing operation starts, the ability of the washing and draining pump 20 is changed over from “LOW” to “HIGH” again and the lower washing operation with the “HIGH” ability of the washing and draining pump 20 is carried out. When further 55 seconds are past thereafter, the solenoid 61 is turned ON for a predetermined time and at the same time the washing and draining pump 20 (pump motor 21) is temporarily stopped, and thereafter the washing and draining pump 20 is driven with the “LOW” ability, so that the upper and lower washing operation with the “LOW” ability of the washing and draining pump 20 is carried out. This upper and lower washing operation with the “LOW” ability of the washing and draining pump 20 is continued till the temperature of wash water reaches 60° C.

When the temperature of wash water reaches 60° C., the solenoid 61 is kept ON for a predetermined time and the ability of the washing and draining pump 20 is changed over to “HIGH”, whereby the lower washing operation with the “HIGH” ability of the washing and draining pump 20 is carried out. When 55 seconds are past after the lower washing operation starts, the ability of the washing and draining pump 20 is changed over from “HIGH” to “LOW” and the lower washing operation with the “LOW” ability of the washing and draining pump 20 is carried out. When further 35 seconds are past thereafter, the solenoid 61 is kept ON for a predetermined time and at the same time the washing and draining pump 20 (pump motor 21) is temporarily stopped, and thereafter the washing and draining pump 20 is driven with the “HIGH” ability again, so that the upper and lower washing operation with the “HIGH” ability of the washing and draining pump 20 is started. This upper and lower washing operation with the “HIGH” ability of the washing and draining pump 20 is continued till the temperature of wash water reaches 70° C. When the temperature of wash water reaches 70° C., the washing and draining pump 20 (pump motor 21) and the heater 116 is turned OFF and the “HEAT-RINSING” step ends.

In the “HEAT-RINSING” step, in order to reduce the water consumption amount, the amount of wash water to be stored in the bottom portion of the washing tank 3 is limited to 3 l similarly to the case of the “WASHING” step. Therefore, when the washing and draining pump 20 is driven with the “HIGH” ability in the upper and lower washing operation, the pump motor 21 is intermittently driven in such a manner that it is normally rotated (ON) for 2 seconds and then stopped (OFF) for 1 second. Thereby, in addition to achieving water saving, excellent dish rinsing can be achieved by spraying wash water with a strong force from the rotary nozzle arms 26 and the fixed nozzle arm 29, and at the same time occurrence of air biting in the washing and draining pump 20 can be prevented.

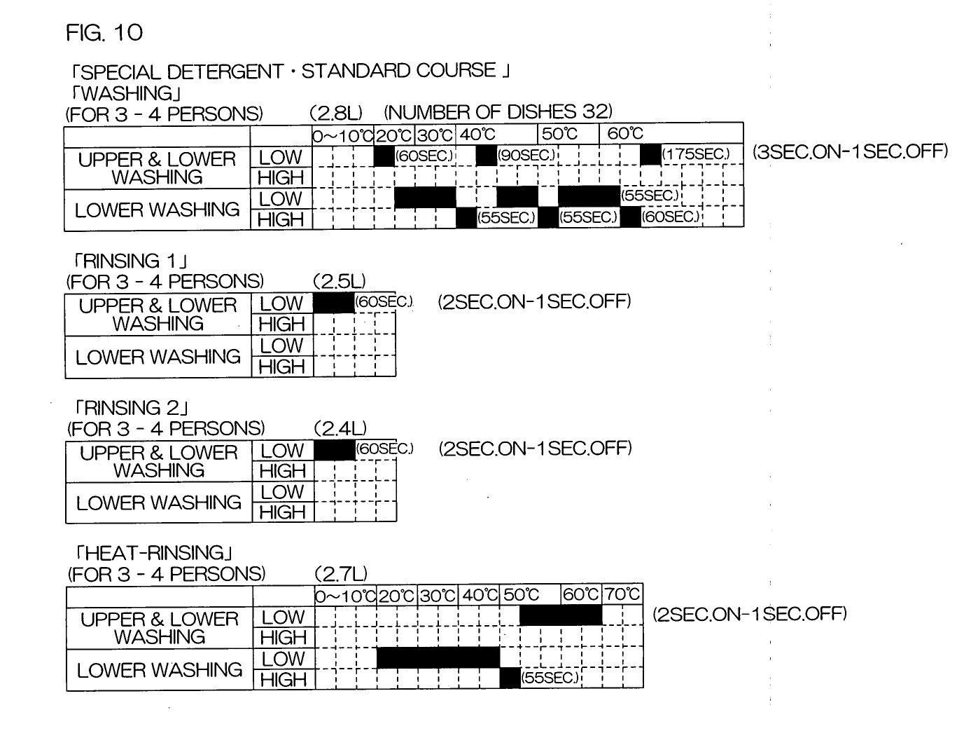

FIG. 10 is a view showing an example of a sequence of dish washing of the dish volume for 3˜4 persons (the number of dishes: 32). The sequence shown in FIG. 10 is applied, for example, when the dish volume for 3˜4 persons is set and the standard course of the special detergent course is selected. At this time, dishes for 3˜4 persons are contained in the lower basket 8B and the upper basket 8A is not used.

When the start/temporary stop key 92 is pressed, water is supplied into the washing tank 3. When 2.8 l of water, which is less than the amount of water stored in the washing tank 3 in the “WASHING” step of the dish volume for 5˜6 persons, is stored in the washing tank 3, a special detergent is solved in the 2.8 l of water to make wash water and a “WASHING” step for washing dishes with the wash water is carried out.

In the “WASHING” step, first, the washing and draining pump 20 is driven with the “LOW” ability with the valve body 42 being situated below the stopper 43, so that the upper and lower washing operation for spraying wash water from both of the rotary nozzle arms 26 and the fixed nozzle arm 29 is carried out. Further, in order to heat wash water stored in the washing tank 3, the heater 116 is energized.

When 60 seconds are past after the “WASHING” step starts, the solenoid 61 is kept ON for a predetermined time, by which the valve body 42 is fitted into the outlet 45B and the water supply into the fixed nozzle arm 29 is hindered, so that the operation is changed over to the lower washing operation for spraying wash water only from the rotary nozzle arms 26. Then, the force of wash water sprayed from the rotary nozzle arms 26 changes from “4” to “2”. This lower washing operation with the “LOW” ability of the washing and draining pump 20 is continued till the temperature of wash water in the washing tank 3 reaches 40° C.

When the temperature of wash water reaches 40° C., the ability of the washing and draining pump 20 is changed over to “HIGH”. Thereby, the force of the wash water sprayed from the rotary nozzle arms 26 changes from “2” to “1”.

When 55 seconds are past after the ability of the washing and draining pump 20 is changed over to “HIGH”, the solenoid 61 is kept ON for a predetermined time and at the same time the washing and draining pump 20 (pump motor 21) is temporarily stopped. Thereby, the valve body 42 moves to a position below the stopper 43. Thereafter, the washing and draining pump 20 is driven with the “LOW” ability again, so that the upper and lower washing operation for spraying wash water from both of the rotary nozzle arms 26 and the fixed nozzle arm 29 is carried out. Thereby, the force of wash water sprayed from the rotary nozzle arms 26 changes from “1” to “4”.

After the upper and lower washing operation with the “LOW” ability of the washing and draining pump 20 is carried out for 90 seconds, the solenoid 61 is kept ON for a predetermined time and the water supply into the fixed nozzle arm 29 is hindered, whereby the lower washing operation with the “LOW” ability of the washing and draining pump 20 is started again. This lower washing operation with the “LOW” ability of the washing and draining pump 20 is continued till the temperature of wash water in the washing tank 3 reaches 50° C.

When the temperature of wash water reaches 50° C., the ability of the washing and draining pump 20 is changed over from “LOW” to “HIGH” and the lower washing operation with the “HIGH” ability of the washing and draining pump 20 is carried out. Then, when 55 seconds are past after the ability of the washing and draining pump 20 is changed over to “HIGH”, the ability of the washing and draining pump 20 is changed over back to “LOW”, and the lower washing operation with the “LOW” ability of the washing and draining pump 20 is carried out again.

Thereafter, when the temperature of wash water reaches 60° C. and further 55 seconds are past, the ability of the washing and draining pump 20 is changed over from “LOW” to “HIGH” and the lower washing operation with the “HIGH” ability of the washing and draining pump 20 is carried out again.

After the lower washing operation with the “HIGH” ability of the washing and draining pump 20 is continued for 60 seconds, the solenoid 61 is kept ON for a predetermined time and at the same time the washing and draining pump 20 (pump motor 21) is temporarily stopped. Thereby, the valve body 42 moves to a position below the stopper 43. Thereafter, the washing and draining pump 20 is driven with the “LOW” ability again, so that the upper and lower washing operation for spraying wash water from both of the rotary nozzle arms 26 and the fixed nozzle arm 29 is carried out. And after the upper and lower washing operation with the “LOW” ability of the washing and draining pump 20 is continued for 175 seconds, the washing and draining pump 20 (pump motor 21) and the heater 116 is turned OFF and this “WASHING” step ends.

In the “WASHING” step, in order to reduce the water consumption amount, the amount of wash water to be stored in the bottom portion of the washing tank 3 is limited to 2.8 l. Therefore, when the washing and draining pump 20 is driven with the “HIGH” ability in the upper and lower washing operation, the pump motor 21 is intermittently driven in such a manner that it is normally rotated (ON) for 3 seconds and then stopped (OFF) for 1 second. Thereby, in addition to achieving water saving, excellent dish washing can be achieved by spraying wash water with a strong force from the rotary nozzle arms 26 and the fixed nozzle arm 29, and at the same time occurrence of air biting in the washing and draining pump 20 can be prevented.

When the “WASHING” step ends, the washing and draining pump 20 is reversely rotated and thereby wash water containing a special detergent stored in the washing tank 3 is drained. Then, water is supplied into the washing tank 3. When 2.5 l of water is stored in the washing tank 3, a “RINSING 1” step for rinsing dishes to which wash water containing a special detergent is adhered is started.

In the “RINSING 1” step, the washing and draining pump 20 is driven with the “LOW” ability. Since the “WASHING” step ends by the upper and lower washing operation, and the valve body 42 is situated below the stopper 43 at the starting point of the “RINSING 1” step, wash water is sprayed from both of the rotary nozzle arms 26 and the fixed nozzle arm 29 when the washing and draining pump 20 is driven with the “LOW” ability. In other words, the upper and lower washing operation with the “LOW” ability of the washing and draining pump 20 is carried out. When 60 seconds are past after the “RINSING 1” step starts, the washing and draining pump 20 (pump motor 21) is stopped and the “RINSING 1” step ends.

In this “RINSING 1” step, the amount of wash water to be stored in the washing tank 3 is limited to 2.5 l, which is lesser than that in the “WASHING” step. Therefore, air biting is apt to occur in the washing and draining pump 20 even if the washing and draining pump 20 is driven with the “LOW” ability. Thus, in the “RINSING 1” step, the pump motor 21 is intermittently driven in such a manner that it is normally rotated (ON) for 2 seconds and then stopped (OFF) for 1 second. Thereby, in addition to achieving further water saving, occurrence of air biting in the washing and draining pump 20 can be surely prevented.

When the “RINSING 1” step ends, the washing and draining pump 20 is reversely rotated and thereby wash water stored in the washing tank 3 is drained. Then, water is supplied into the washing tank 3 again. When 2.4 l of water is stored in the washing tank 3, a “RINSING 2” step for rinsing dishes is started.

In the “RINSING 2” step, the washing and draining pump 20 is also driven with the “LOW” ability and the upper and lower washing operation for spraying wash water from both of the rotary nozzle arm 26 and the fixed nozzle arm 29 is carried out. When 60 seconds are past after the “RINSING 2” step starts, the washing and draining pump 20 (pump motor 21) is stopped and the “RINSING 2” step ends.

Also, in this “RINSING 2” step, the amount of wash water to be stored in the washing tank 3 is limited to 2.4 l, which is smaller than that in the “WASHING” step. Therefore, the pump motor 21 is intermittently driven in such a manner that it is normally rotated (ON) for 2 seconds and then stopped (OFF) for 1 second. Thereby, in addition to achieving further water saving, occurrence of air biting in the washing and draining pump 20 can be prevented.

When the “RINSING 2” step ends, the washing and draining pump 20 is reversely rotated and thereby wash water stored in the washing tank 3 is drained. Then, water is supplied into the washing tank 3 again. When 2.7 l of water is stored in the washing tank 3, a “HEAT-RINSING” step for rinsing dishes with hot water is started.

In the “HEAT-RINSING” step, first, the heater 116 is energized and the washing and draining pump 20 is driven with the “LOW” ability. Then, the solenoid 61 is kept ON for a predetermined time, by which the valve body 42 is fitted into the outlet 45B. Thereby, the water supply into the fixed nozzle arm 29 is hindered and the lower washing operation for spraying wash water only from the rotary nozzle arms 26 is carried out.

The lower washing operation with the “LOW” ability of the washing and draining pump 20 is continued till the temperature of wash water in the washing tank 3 reaches 50° C.

When the temperature of wash water reaches 50° C., the ability of the washing and draining pump 20 is changed over from “LOW” to “HIGH” and the lower washing operation with the “HIGH” ability of the washing and draining pump 20 is carried out. When 55 seconds are past after the ability of the washing and draining pump 20 is changed over to “HIGH”, the solenoid 61 is kept ON for a predetermined time and at the same time the washing and draining pump 20 is temporarily stopped and thereafter the washing and draining pump 20 is driven with the “LOW” ability again, so that the upper and lower washing operation with the “LOW” ability of the washing and draining pump 20 is continued till the temperature of wash water reaches 70° C. When the temperature of wash water reaches 70° C., the washing and draining pump 20 (pump motor 21) and the heater 116 is turned OFF and this “HEAT-RINSING” step ends.

In the “HEAT-RINSING” step, in order to reduce the water consumption amount, the amount of wash water to be stored in the bottom portion of the washing tank 3 is limited to 2.7 l. Therefore, in the upper and lower washing operation, the pump motor 21 is intermittently driven in such a manner that it is normally rotated (ON) for 2 seconds and then stopped (OFF) for 1 second. Thereby, in addition to achieving water saving, excellent dish rinsing can be achieved by spraying wash water with a strong force from the rotary nozzle arms 26 and the fixed nozzle arm 29, and at the same time occurrence of air biting in the washing and draining pump 20 can be prevented.

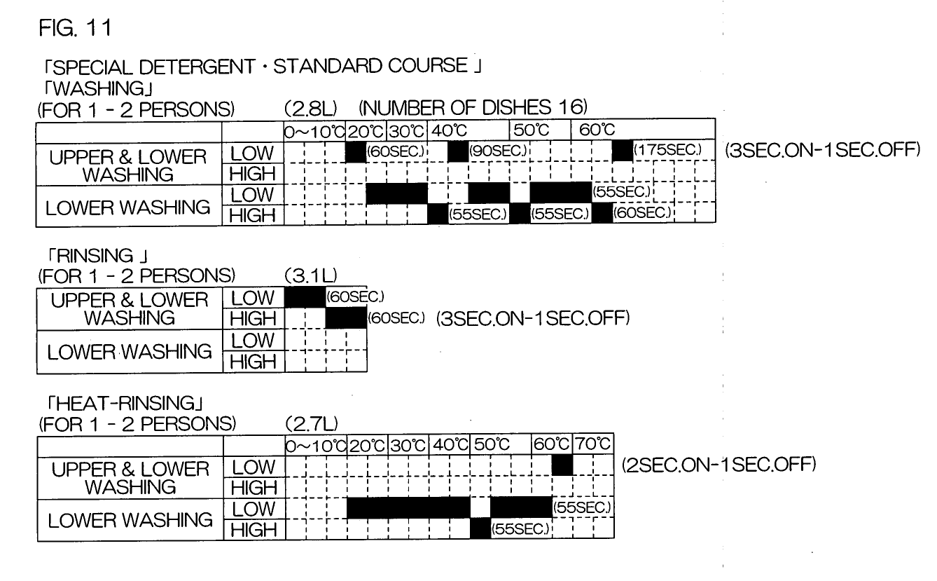

FIG. 11 is a view showing an example of a sequence of dish washing of the dish volume for 1˜2 persons (the number of dishes: 16). The sequence shown in FIG. 11 is applied, for example, when the dish volume for 1˜2 persons is set and the standard course of the special detergent course is selected. At this time, dishes for 1˜2 persons are contained in the lower basket 8B and the upper basket 8A is not used.

When the start/temporary stop key 92 is pressed, water is supplied into the washing tank 3. When 2.8 l of water is stored into the washing tank 3, a special detergent is solved into the 2.8 l of water to make wash water. Then, a “WASHING” step for washing dishes with the wash water is carried out. This “WASHING” step is similar to the “WASHING” step shown in FIG. 10 (“WASHING” step in the case of the dish volume for 3˜4 persons) and therefore the description thereof is omitted.

When the “WASHING” step ends, the washing and draining pump 20 is reversely rotated and thereby wash water containing a special detergent stored in the washing tank 3 is drained. Then, water is supplied into the washing tank 3. When 3.1 l of water is stored in the washing tank 3, a “RINSING” step for rinsing dishes to which wash water containing a special detergent is adhered is started.

In this “RINSING” step, a larger amount of water is used than that used in the “RINSING 1” step or the “RINSING 2” step for the dish volume for 3˜4 persons. However, in the case of the dish volume for 1˜2 persons, the step of rinsing dishes is carried out only once unlike the case of the dish volume for 3˜4 persons. Thereby, the amount of water used for rinsing dishes can be reduced as a result.

In the “RINSING” step, the washing and draining pump 20 is driven with the “LOW” ability. Since the “WASHING” step ends by the upper and lower washing operation, and the valve body 42 is situated below the stopper 43 at the starting point of the “RINSING” step, wash water is sprayed from both of the rotary nozzle arms 26 and the fixed nozzle arm 29 when the washing and draining pump 20 is driven with the “LOW” ability. In other words, the upper and lower washing operation with the “LOW” ability of the washing and draining pump 20 is carried out.

After the upper and lower washing operation with the “LOW” ability of the washing and draining pump 20 is continued for 60 seconds, the ability of the washing and draining pump 20 is changed over from “LOW” to “HIGH” and the upper and lower washing operation with the “HIGH” ability of the washing and draining pump 20 is carried out. After the upper and lower washing operation with the “HIGH” ability of the washing and draining pump 20 is continued for 60 seconds, the washing and draining pump 20 (pump motor 21) is turned OFF and the “RINSING” step ends.

In this “RINSING” step, the amount of wash water to be stored in the washing tank 3 is limited to 3.1 l in order to reduce the water consumption amount. Therefore, when the washing and draining pump 20 is driven with the “HIGH” ability in the upper and lower washing operation, the pump motor 21 is intermittently driven in such a manner that it is normally rotated (ON) for 3 seconds and then stopped (OFF) for 1 second. Thereby, in addition to achieving water saving, excellent dish rinsing can be achieved by spraying wash water with a strong force from the rotary nozzle arms 26 and the fixed nozzle arm 29 and at the same time occurrence of air biting in the washing and draining pump 20 can be prevented.

When the “RINSING” step ends, the washing and draining pump 20 is reversely rotated and thereby wash water stored in the washing tank 3 is drained. Then, water is supplied into the washing tank 3 again. When 2.7 l of water is stored in the washing tank 3, a “HEAT-RINSING” step is started.

In the “HEAT-RINSING” step, first, energization of the heater 116 is started and the washing and draining pump 20 is driven with the “LOW” ability. Then, the solenoid 61 is kept ON for a predetermined time, by which the valve body 42 is fitted into the outlet 45B. Thereby, the water supply into the fixed nozzle arm 29 is hindered and the lower washing operation for spraying wash water only from the rotary nozzle arms 26 is carried out.

This lower washing operation with the “LOW” ability of the washing and draining pump 20 is continued till the temperature of wash water in the washing tank 3 reaches 50° C.

When the temperature of wash water in the washing tank 3 reaches 50° C., the ability of the washing and draining pump 20 is changed over from “LOW” to “HIGH” and the lower washing operation with the “HIGH” ability of the washing and draining pump 20 is carried out. Thereafter, when 55 seconds are past after the ability of the washing and draining pump 20 is changed over to “HIGH”, the ability of the washing and draining pump 20 is turned back to “LOW”, and the lower washing operation with the “LOW” ability of the washing and draining pump 20 is carried out again.

Thereafter, when the temperature of wash water reaches 60° C. and further 55 seconds are past, the ability of the washing and draining pump 20 is changed over from “LOW” to “HIGH” and the lower washing operation with the “HIGH” ability of the washing and draining pump 20 is carried out again. When the temperature of the wash water in the washing tank 3 reaches 70° C., the washing and draining pump 20 (pump motor 21) and the heater 116 are turned OFF and this “HEAT-RINSING” step ends.

In this “HEAT-RINSING” step, the amount of wash water to be stored in the washing tank 3 is limited to 2.7 l similarly to the case of the “HEAT-RINSING” step in the dish washing of the dish volume for 3˜4 persons. Therefore, in the upper and lower washing operation, the pump motor 21 is intermittently driven in such a manner that it is normally rotated (ON) for 2 seconds and then stopped (OFF) for 1 second. Thereby, in addition to achieving further water saving, excellent dish washing can be achieved by spraying wash water with a strong force from the rotary nozzle arms 26 and the fixed nozzle arm 29 and at the same time occurrence of air biting in the washing and draining pump 20 can be prevented.

As abovementioned, according to this embodiment, in the dish washing using both of the upper basket 8A and the lower basket 8B, i.e. the dish washing of the dish volume for 5-6 persons, the upper and lower washing operation for spraying wash water from both of the rotary nozzle arms 26 and the fixed nozzle arm 29 and the lower washing operation for spraying wash water only from the rotary nozzle arms 26 are mixedly carried out in such a manner that the upper and lower washing time (total time) becomes longer than the lower washing operation time (total time). That is, in the dish washing of the dish volume for 5˜6 persons, wash water is in principle sprayed from both of the rotary nozzle arms 26 and the fixed nozzle arm 29, and in the midway thereof, a term is set in which wash water spraying from the fixed nozzle arm 29 is stopped and wash water is sprayed only from the rotary nozzle arms 26.

Thereby, sometimes, wash water is sprayed from the rotary nozzle arms 26 with a strong force and the direction of wash water sprayed from the rotary nozzle arms 26 changes, so that even if the upper basket 8A and lower basket 8B are full of dishes, wash water can reach all of the dishes and excellent dish washing can be achieved.

In addition to this, since the ability of the washing and draining pump 20 can be changed over between “HIGH” and “LOW”, the force of wash water sprayed from the rotary nozzle arms 26 (and the fixed nozzle arm 29) changes. Therefore, as in the dish washing using both of the upper basket 8A and the lower basket 8B, the changing over of the ability of the washing and draining pump 20 and the changing over of the upper and lower washing operation and the lower washing operation are performed in combination, whereby the force of wash water sprayed from the rotary nozzle arms 26 can be changed by four stages and the direction of wash water sprayed from the rotary nozzle arms 26 can be changed into four directions corresponding to the force of the wash water. As a result, wash water can surely reach all the dishes and more excellent dish washing can be achieved.

Further, in the upper and lower washing operation, when the temperature of wash water reaches 40° C. and when the temperature of wash water reaches 50° C., the ability of the washing and draining pump 20 is changed over from “LOW” to “HIGH” thus to strengthen the force of wash water sprayed from the rotary nozzle arms 26 and the fixed nozzle arm 29. Thereby, various kinds of soils adhered to dishes can be surely washed away.

In other words, generally, the main components of soils adhered to dishes are protein-based, starch-based and oil-based components. It is said that one having the lowest thermal coagulation temperature of proteins begins to coagulate at about 42° C. Therefore, by changing over the ability of the washing and draining pump 20 from “LOW” to “HIGH” when the temperature of wash water reaches 40° C., wash water at such a temperature as capable of preventing coagulation of all kinds of proteins can be sprayed toward dishes and thus protein-based soils can be effectively washed away.

Further, protein decomposing enzymes contained in a special dish washing detergent are most activated at about 50° C., while many proteins thermally coagulate at or above 52° C. Accordingly, by changing over the ability of the washing and draining pump 20 from “LOW” to “HIGH” when the temperature of wash water reaches 40° C., for example, it becomes possible to strongly spray wash water at such a temperature as capable of preventing coagulation of many proteins toward dishes and to effectively wash away protein-based soils while bringing out the abilities of protein decomposing enzymes contained in the detergent. Further, among animal fats and oils, lard (pig tallow oil) has a melting point of about 28˜48° C. (mainly 36˜42° C.) and beef fat (beef tallow oil) has a melting point of about 35˜55° C. (mainly 40˜48° C.). Therefore, when the predetermined temperature is set at 50° C., wash water at such a temperature as capable of liquefying almost all of animal fats and oils can be strongly sprayed toward dishes, so that oily soils adhered to dishes can be also effectively washed away.

Furthermore, when the temperature of wash water reaches 60° C., the operation is changed over from the upper and lower washing operation to the lower washing operation corresponding thereto. Thereby, wash water reaching 60° C. can be sprayed with a strong force toward dishes so that soils of such kinds as capable of being washed away by wash water reaching 60° C. can be surely washed away.

That is, the starch decomposing enzymes are most active at a temperature about 60° C., and the solubility of a detergent is promoted and the original washing ability thereof is apt to be displayed as the temperature of wash water rises. Accordingly, by changing over the operation from the upper and lower washing operation to the lower washing operation when the temperature of wash water reaches 60° C. thus to strengthen the force of wash water sprayed from the rotary nozzle arms 26, starch-based soils sticking to dishes can be effectively washed away and at the same time oily soils remaining on dishes can be effectively washed away.

Further, when wash water is suddenly sprayed with a strong force from the rotary nozzle arms 26 (and the fixed nozzle arm 29) after each operation of the upper and lower washing operation and the lower washing operation starts, the sounds of splashing water such as noises generated from the sprayed wash water hitting the inner surface of the washing tank 3 or dishes will be noisy. However, since the ability of the washing and draining pump 20 is changed over from “LOW” to “HIGH” in the way of the upper and lower washing operation and the lower washing operation, the sound of splashing water can be made louder stepwise, thus to prevent the sound from becoming noisy.

Also, in the dish washing using only the lower basket 8B, that is, the dish washing of the dish volume for 3˜4 persons or for 1˜2 persons, in the “WASHING” step and the “HEAT-RINSING” step, the upper and lower washing operation for spraying wash water from both of the rotary nozzle arms 26 and the fixed nozzle arm 29 and the lower washing operation for spraying wash water only from the rotary nozzle arms 26 are mixedly carried out in such a manner that the lower washing operation time (total time) is longer than the upper and lower washing operation time (total time) That is, in the dish washing of the dish volume for 3˜4 persons or for 1˜2 persons, wash water is in principle sprayed only from the rotary nozzle arms 26, and in the midway thereof, a term is set in which wash water is sprayed from both of the rotary nozzle arms 26 and the fixed nozzle arm 29.

Thereby, since wash water is sprayed sometimes from above toward dishes contained in the lower basket 8B, wash water can reach dishes disposed in such positions that wash water from the rotary nozzle arms 26 is hard to reach. Therefore, excellent dish washing can be achieved.

In addition to this, in the “WASHING” step and the “HEAT-RINSING” step in the dish washing using only the lower basket 8B, by changing over the ability of the washing and draining pump 20 from “LOW” to “HIGH” in the lower washing operation, the force of wash water sprayed from the rotary nozzle arms 26 (and the fixed nozzle arm 29) is strengthened. Thereby, wash water can reach dishes disposed in such positions that wash water sprayed with a weak force from the rotary nozzle arms 26 is hard to reach, and more excellent dish washing can be achieved.

Further, when wash water is suddenly sprayed with a strong force from the rotary nozzle arms 26 after operation of the lower washing operation starts, the sounds of splashing water such as noises generated from the sprayed wash water hitting the inner surface of the washing tank 3 or dishes will be noisy. However, since the ability of the washing and draining pump 20 is changed over from “LOW” to “HIGH” in the way of the lower washing operation, the sound of splashing water can be made stepwise louder, thus to prevent the sound from becoming noisy.

Further, in the “RINSING 1” step and the “RINSING 2” step in the dish washing of the dish volume for 3˜4 persons and in the “RINSING” step in the dish washing of the dish volume for 1˜2 persons, wash water is sprayed from both of the rotary nozzle arms 26 and the fixed nozzle arm 29. Thereby, wash water can be more uniformly sprayed toward dishes contained in the lower basket 8B in comparison with the case of spraying wash water only from the rotary nozzle arms 26. Thus, excellent rinsing of dishes can be achieved.

Further, in the “RINSING” step in the dish washing of the dish volume for 1˜2 persons, by changing over the ability of the washing and draining pump 20 from “LOW” to “HIGH” in the upper and lower washing operation, the force of wash water sprayed from the rotary nozzle arms 26 and the fixed nozzle arm 29 is strengthened. Thereby, even though the step for rinsing dishes is carried out only once, excellent dish washing can be achieved. Thus, in the dish washing of the dish volume for 1˜2 persons, water consumption amount can be reduced and at the same time excellent rinsing of dishes can be achieved.

In this embodiment, described is an example in which, by selectively turning on the first triac 124 and the second triac 125 thus to change over the electric current supply to the pump motor 21 between large and small, the ability of the washing and draining pump 20 (the rotational number of the pump motor 21) is changed over between “HIGH” and “LOW”, so that in each step such as “WASHING” step, the ability of the washing and draining pump 20 can be changed over by two stages between “HIGH” and “LOW”. However, it is possible that, for example, by adopting an inverter circuit as a driving circuit of the pump motor 21, the ability of the washing and draining pump 20 is changed over by three stages comprising “HIGH”, “MIDDLE” and “LOW” or more than three stages in each step such as the “WASHING” step. By changing over the ability of the washing and draining pump 20 by more than two stages, the force of wash water sprayed from the rotary nozzle arms 26 and the fixed nozzle arm 29 can be more finely changed. In accompany with this, the directions of wash water sprayed from the rotary nozzle arms 26 and the fixed nozzle arm 29 can be more finely changed. As a result, more excellent dish washing can be achieved.

While the present invention has been described in detail by way of the embodiments thereof, it should be understood that the foregoing disclosure is merely illustrative of the technical principles of the present invention but not limitative of the same. The spirit and scope of the present invention are to be limited only by the appended claims.

This application corresponds to the Japanese Patent Application No. 2004-241955 filed with the Japan Patent Office on Aug. 23, 2004, and the whole disclosure of which is incorporated herein by reference.

What is claimed is:

1. A dish washing machine comprising:
an upper basket and a lower basket doubly disposed for containing dishes;
a first nozzle for spraying wash water toward dishes contained in the upper basket;
a second nozzle disposed below the lower basket for spraying wash water toward dishes contained in the lower basket;
a wash water supply channel for supplying wash water to the first nozzle and the second nozzle;
a change over means for changing over between supplying and not supplying wash water flowing through the wash water supply channel to the first nozzle; and
an operation control means for controlling the change over means to carry out a double washing operation for spraying wash water from both of the first nozzle and the second nozzle and a single washing operation for spraying wash water only from the second nozzle while stopping wash water supply to the first nozzle so as to wash dishes contained in the upper basket and the lower basket.

2. A dish washing machine according to claim 1, further comprising:
a washing tank capable of storing wash water in the bottom portion thereof;
a pump for sucking out wash water stored in the bottom portion of the washing tank and supplying the wash water to the wash water supply channel; and
an ability change over means for changing over the ability of the pump between HIGH and LOW.

3. A dish washing machine according to claim 2, further comprising a double washing operation time ability control means for controlling the ability change over means to change over the ability of the pump from LOW to HIGH in the double washing operation.

4. A dish washing machine according to claim 3, further comprising:
a heating means for heating wash water stored in the washing tank; and
a water temperature detecting means for detecting the temperature of wash water stored in the washing tank, in which
the double washing operation time ability control means changes over the ability of the pump from LOW to HIGH when the water temperature detecting means detects that the temperature of wash water reaches a predetermined temperature.

5. A dish washing machine according to claim 3, in which the operation change over means changes over from the double washing operation to the single washing operation when a predetermined time is past after the ability of the pump is changed over to HIGH by the double washing operation time ability control means.

6. A dish washing machine according to claim 2, further comprising a single washing operation time ability control means for controlling the ability change over means to change over the ability of the pump from LOW to HIGH in the single washing operation.

7. A dish washing machine according to claim 1, further comprising
a heating means for heating wash water stored in the washing tank, and
a water temperature detecting means for detecting the temperature of wash water stored in the washing tank, in which
the operation control means changes over from the double washing operation to the single washing operation when the water temperature detecting means detects that the temperature of wash water reaches a predetermined temperature.

8. A dish washing machine according to claim 1, in which wash water is detergent water containing a detergent.

9. A dish washing machine according to claim 1, in which wash water is rinsing water not containing detergent.

10. A dish washing machine comprising:
an upper basket and a lower basket doubly disposed for containing dishes;
a first nozzle for spraying wash water toward dishes contained in the upper basket;
a second nozzle for spraying wash water toward dishes contained in the lower basket;
a wash water supply channel for supplying wash water to the first nozzle and the second nozzle;
a change over means for changing over between supplying and not supplying wash water flowing through the wash water supply channel to the first nozzle; and
an operation control means for controlling the change over means to carry out a single washing operation for spraying wash water only from the second nozzle while stopping wash water supply to the first nozzle and a double washing operation for spraying wash water from both of the first nozzle and the second nozzle so as to wash dishes contained in the lower basket.

11. A dish washing machine according to claim 10, further comprising:
a washing tank capable of storing wash water in the bottom portion thereof;
a pump for sucking out wash water stored in the bottom portion of the washing tank and supplying the wash water to the wash water supply channel;
an ability change over means for changing over the ability of the pump between HIGH and LOW; and
a single washing operation time ability control means for controlling the ability change over means to change over the ability of the pump from LOW to HIGH in the single washing operation.

12. A dish washing machine according to claim 11, further comprising:
a heating means for heating wash water stored in the washing tank; and
a water temperature detecting means for detecting the temperature of wash water stored in the washing tank, in which
the single washing operation time ability control means changes over the ability of the pump from LOW to HIGH when the water temperature detecting means detects that the temperature of wash water reaches a predetermined temperature.

13. A dish washing machine according to claim 12, in which the operation change over means changes over from the single washing operation to the double washing operation when a predetermined time is past after the ability of the pump is changed over to HIGH by the single washing operation time ability control means.

14. A dish washing machine according to claim 10, further comprising:
a heating means for heating wash water stored in the washing tank; and
a water temperature detecting means for detecting the temperature of wash water stored in the washing tank, in which
the operation control means changes over from the double washing operation to the single washing operation when the water temperature detecting means detects that the temperature of wash water reaches a predetermined temperature.

15. A dish washing machine according to claim 10, in which wash water is detergent water containing a detergent.

16. A dish washing machine according to claim 10, further comprising an operation control means for controlling the change over means to carry out a rinsing operation for spraying rinsing water not containing a detergent from both of the first nozzle and the second nozzle so as to rinse dishes contained in the lower basket.

17. A dish washing machine according to claim 16, further comprising:
a washing tank capable of storing wash water in the bottom portion thereof;
a pump for sucking out wash water stored in the bottom portion of the washing tank and supplying the wash water to the wash water supply channel;
an ability change over means for changing over the ability of the pump between HIGH and LOW; and
a rinsing operation time ability control means for controlling the ability change over means to change over the ability of the pump from LOW to HIGH in the rinsing operation.

18. A dish washing machine comprising:
a washing tank capable of storing wash water in the bottom portion thereof;
a water catchment section for collecting wash water provided in the bottom portion of the washing tank;
a pump driven by a pump motor to suck out wash water from the water catchment section; and
nozzles for spraying wash water sucked out by the pump,
in which the amount of wash water stored in the bottom portion of the washing tank is limited to a predetermined amount,
further comprising:
a rotational speed change over means for changing over the rotational speed of the pump motor at least by two stages consisting of a low rotational speed not bringing air biting in the pump even if the pump motor is continuously driven and a high rotational speed bringing air biting in the pump if the pump motor is continuously driven because the amount of wash water stored in the bottom portion of the washing tank is limited to a predetermined amount; and
a pump motor control means for intermittently operating the pump motor at the time of rotating the pump motor at the high rotational speed.
